(19) United States
(12) Patent Application Publication
(10) Pub. No.: US 2024/0381186 A1
(43) Pub. Date: Nov. 14, 2024

(54) METHOD AND APPARATUS FOR RESETTING DOWNLINK HARQ FOR MULTICAST RECEPTION

(71) Applicant: SAMSUNG ELECTRONICS CO., LTD., Suwon-si (KR)

(72) Inventors: Sangkyu BAEK, Suwon-si (KR); Jaehyuk JANG, Suwon-si (KR)

(21) Appl. No.: 18/660,066

(22) Filed: May 9, 2024

(30) Foreign Application Priority Data
May 11, 2023 (KR) 10-2023-0061235

(51) Int. Cl. H04W 36/00; H04L 1/1829; H04W 36/08

(52) U.S. Cl. CPC H04W 36/0007; H04L 1/1835; H04W 36/08

(57) ABSTRACT

The disclosure relates to a 5G or 6G communication system for supporting a higher data transmission rate. A method performed by a user equipment (UE) in a wireless communication system is provided. The method comprises receiving a radio resource control (RRC) release message including multicast and broadcast services (MBS) configuration information associated with reception of an MBS multicast in an RRC inactive state, performing cell reselection while the UE is in the RRC inactive state and resetting a medium access control (MAC) entity upon the cell reselection.

### CROSS-REFERENCE TO RELATED APPLICATION

This application is based on and claims priority under 35 U.S.C. § 119 to Korean Patent Application No. 10-2023-0061235, filed on May 11, 2023, in the Korean Intellectual Property Office, the disclosure of which is herein incorporated by reference in its entirety.

### BACKGROUND

### 1. Field

The disclosure relates to a wireless communication system and, more particularly, to a method and an apparatus for resetting a downlink hybrid automatic repeat request (HARQ) for a multicast reception.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

A method performed by a user equipment (UE) in a wireless communication system is provided. The method comprises receiving a radio resource control (RRC) release message including multicast and broadcast services (MBS) configuration information associated with reception of an MBS multicast in an RRC inactive state, performing cell reselection while the UE is in the RRC inactive state and resetting a medium access control (MAC) entity upon the cell reselection.

A user equipment (UE) in a wireless communication system is provide. The UE comprises a transceiver and a controller coupled with the transceiver and configured to receive a radio resource control (RRC) release message including multicast and broadcast services (MBS) configuration information associated with reception of an MBS multicast in an RRC inactive state, perform cell reselection while the UE is in the RRC inactive state, and reset a medium access control (MAC) entity upon the cell reselection.

A method performed by a user equipment (UE) in a wireless communication system is provided. The method comprises receiving a radio resource control (RRC) release message including multicast and broadcast services (MBS) configuration information associated with reception of an MBS multicast in an RRC inactive state, receiving, from a base station, a RRC resume message while the UE is in the RRC inactive state and resetting a medium access control (MAC) entity based on the RRC resume message.

A user equipment (UE) in a wireless communication system is provide. The UE comprises a transceiver and a controller coupled with the transceiver and configured to receive a radio resource control (RRC) release message including multicast and broadcast services (MBS) configuration information associated with reception of an MBS multicast in an RRC inactive state, receive, from a base station, a RRC resume message while the UE is in the RRC inactive state, and reset a medium access control (MAC) entity based on the RRC resume message.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of an MBS communication operation scheme according to an embodiment of the present disclosure;

FIG. 2 illustrates an example of an operation for resetting a downlink HARQ during a cell reselection according to an embodiment of the present disclosure;

FIG. 3 illustrates an example of an operation for resetting a downlink HARQ during an activation of G-RNTI monitoring according to an embodiment of the present disclosure;

FIG. 4 illustrates an example of an operation for resetting a downlink HARQ during a deactivation of G-RNTI monitoring according to an embodiment of the present disclosure;

FIG. 5 illustrates an example of an operation for resetting a downlink HARQ during a multicast reception in an inactive mode according to an embodiment of the present disclosure;

FIG. 6 illustrates an example of an operation for resetting a downlink HARQ during a multicast reception in an inactive mode according to an embodiment of the present disclosure;

FIG. 7 illustrates an example of an operation for resetting a downlink HARQ during an RRC state transition according to an embodiment of the present disclosure;

FIG. 8 illustrates an example of an operation for resetting a downlink HARQ during an RRC state transition according to an embodiment of the present disclosure;

FIG. 9 illustrates an example of a gNB according to an embodiment of the present disclosure; and

FIG. 10 illustrates an example of a UE according to an embodiment of the present disclosure.

### DETAILED DESCRIPTION

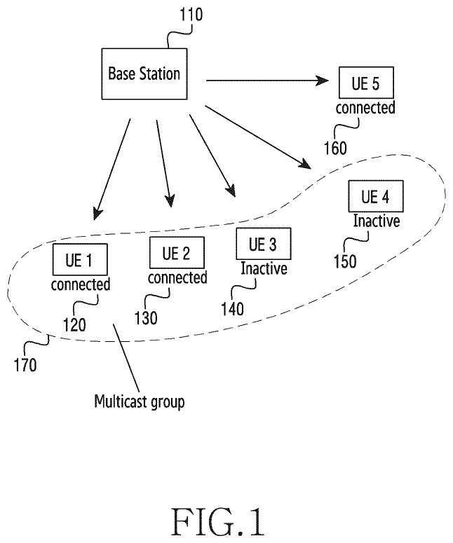

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In the following description of the disclosure, detailed descriptions of known functions or configurations incorporated herein will be omitted when it is determined that the description may make the subject matter of the disclosure unnecessarily unclear. Hereinafter, embodiments of the disclosure will be described with reference to the accompanying drawings.

In describing the embodiments in the specification, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are provided with the same or corresponding reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card.

The following detailed description of embodiments of the disclosure is mainly directed to new RAN (NR) as a radio access network and packet core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the 5G system, a network data collection and analysis function (NWDAF), which is a network function for analyzing and providing data collected in a 5G network, may be defined to support network automation. The NWDAF may collect/store/analyze information from the 5G network and provide the results to unspecified network functions (NFs), and the analysis results may be used independently in each NF.

In the following description, some of terms and names defined in the 3GPP standards (standards for 5G, new radio (NR), long term evolution (LTE), or similar systems) may be used for the sake of descriptive convenience. However, the disclosure is not limited by these terms and names, and may be applied in the same way to systems that conform other standards.

An embodiment of the disclosure provides an apparatus and a method capable of effectively providing a service in a mobile communication system.

According to an embodiment of the disclosure, a method for processing control signals in a wireless communication system may include receiving a first control signal transmitted from a gNB, processing the received first control signal, and transmitting a second control signal generated based on the processing to the gNB.

An embodiment of the disclosure may provide an apparatus and a method capable of effectively providing a service in a mobile communication system.

Advantageous effects obtainable from the disclosure may not be limited to the above-mentioned effects, and other effects which are not mentioned may be clearly understood, through the following descriptions, by those skilled in the art to which the disclosure pertains.

FIG. 1 illustrates an example of an MBS communication operation scheme according to an embodiment of the present disclosure.

Referring to FIG. 1, the multicast and broadcast service (MBS) communication according to an embodiment refers to one of communication schemes of a mobile communication system in which one transmitting device communicates with multiple receiving devices. For example, the transmitting device may be a gNB, and respective receiving devices may be UEs. However, this is not limitative, and the transmitting device may be a UE. For example, the transmitting device may be a UE, and the respective receiving devices may be gNBs. As another example, the transmitting device may be a UE, and the receiving devices may be relays or remote UEs configured to perform side link communication.

According to an embodiment, the embodiment in FIG. 1 illustrates an example in which MBS communication is performed assuming that the gNB 110 is a transmitting device, and the UEs 120, 130, 140, 150, and 160 are receiving devices. For example, the MBS communication may be a broadcast type of communication for unspecified multiple entities, or a multicast type of communication for specified multiple receiving devices. For example, in case that the MBS communication is performed in the multicast type, the gNB 110 may configure only specific UEs (for example, UE 1 120 and UE 2 130) to be able to receive multicast packets.

According to an embodiment, in case that multicast communication is performed for specific multiple receiving devices, a set of UEs may be configured to perform specific multicast communication. For example, in the embodiment in FIG. 1, the set of UEs configured to perform specific multicast communication may be referred to as a multicast group 170. As another example, the scheme in which a gNB (e.g., the gNB 110) and a UE (e.g., UE 1 120) perform one-to-one communication may be referred to as unicast.

According to an embodiment, UEs in the multicast group may have substantially the same resource identifier (e.g., group-radio network temporary identity (G-RNTI)) allocated thereto, thereby receiving data allocated based on the allocated G-RNTI. For example, the G-RNTI allocated to the UEs may be an RNTI shared by the UEs in the multicast group, and the UEs having the G-RNTI allocated to may receive radio resources for the MBS service from the gNB.

According to an embodiment, the UE 1 120, the UE 2 130, the UE 3 140, and/or the UE 4 150 in FIG. 1 may be configured as one multicast group, and the UEs included in the multicast group may have a G-RNTI allocated or configured by the gNB 110 to receive data from the gNB 110 in a multicast type.

According to an embodiment, the UE 5 160 is not included in the multicast group and thus cannot have a G-RNTI allocated or configured therefor. Accordingly, the UE 5 160 cannot receive the data which the UE 1 120, the UE 2 130, the UE 3 140, and/or the UE 4 150 receive from the gNB.

According to an embodiment, at least one multicast group may be configured in the coverage of the gNB 110, and each multicast group may be distinguished by the G-RNTI. One UE may have one or more G-RNTIs allocated by the gNB 110. For example, one UE (for example, UE 1 120) may be included in or belong to first and second multicast groups, and one UE may have multiple G-RNTIs (for example, two G-RNTIs) allocated or configured therefor.

According to an embodiment, a UE (for example, UE 1 120) may receive multicast data by using a G-RNTI value allocated in a connected mode (radio resource control connected mode) not only in the connected mode, but also in an inactive mode (RRC inactive mode). The G-RNTI may be included in at least one of an RRC reconfiguration message received by the UE in the connected mode, an RRC setup (or establishment) message, an RRC reestablishment message, or an RRC release message. However, the message or information including the G-RNTI is not limited to the above-mentioned examples, and the G-RNTI may be included in a system information block (SIB) as a G-RNTI value which the UE can receive, and then transmitted from the gNB. Upon having the G-RNTI value configured therefor, the UE may apply the G-RNTI value after the same is configured.

According to an embodiment, in case that the gNB 110 wants to perform multicasting in the connected mode or wants to deliver configuration information for multicast communication, including a G-RNTI, to a UE in the connected mode, UEs in the multicast group may need to transition to the connected mode. For example, the gNB 110 may transmit configuration information or a message such that UEs in the multicast group transition to the connected mode.

According to an embodiment, a UE receiving a multicast service in the inactive mode may need to transition to the connected mode because it is difficult to receive the multicast service in the inactive mode due to reduced signal strength or the like. Among the UEs in the multicast group 170 in FIG. 1, the UE 1 120 and the UE 2 130 may be in the connected mode, and the UE 3 140 and the UE 4 150 may be in the inactive mode. The gNB 110 may indicate or transmit a multicast configuration to UEs, and UEs in the connected mode or inactive mode may receive a multicast service or multicast data.

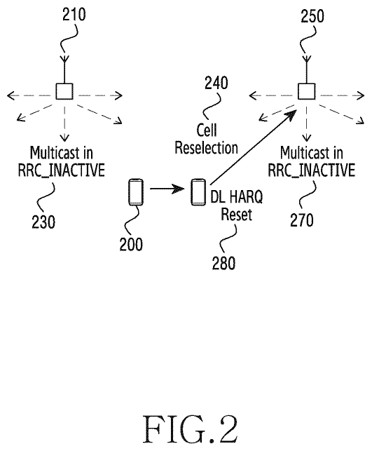

FIG. 2 illustrates an example of an operation for resetting a downlink hybrid automatic repeat request (HARQ) during cell reselection according to an embodiment of the present disclosure.

Referring to FIG. 2, during multicast reception in an inactive mode, a UE according to an embodiment may receive, from a gNB, configuration information for performing multicast reception in the active mode through at least one of an RRC reconfiguration message, an RRC setup or establishment message, an RRC reestablishment message, or an RRC release message in a connected mode.

According to an embodiment, the UE may receive, from the gNB, configuration information for performing multicast reception by using a multicast control channel (MCCH) received in the inactive state. The UE may perform multicast reception in the inactive mode, based on the received configuration information for multicast data reception.

According to an embodiment, upon discovering a gNB (e.g., second gNB) having a more excellent signal strength than the gNB (e.g., first gNB) on which the UE currently camps in the inactive mode, the UE may perform cell reselection. If the configuration information for performing multicast reception in the inactive mode configured by the previous gNB (e.g., first gNB) is configured such that the UE can perform multicast reception in the reselected cell of the second gNB, the UE may continuously perform multicast reception in the inactive mode without transitioning to the connected mode. In order to perform multicast reception in the inactive mode without a transition, the UE may receive information regarding whether a multicast service is provided to inactive mode UEs by an adjacent gNB (e.g., second gNB) through at least one of an RRC reconfiguration message, an RRC establishment message, an RRC reestablishment message, or an RRC release message in a connected mode. Upon determining, based on the received information, that a multicast service is being provided in the inactive mode by the cell reselected by the UE, the UE may continuously perform multicast reception in the inactive mode.

According to an embodiment, the multicast service configured to be received by the UE in the inactive mode may have a temporary mobile group identity (TMGI) of the multicast identifier configured therefor. In addition, a G-RNTI may be configured to receive the multicast service. For example, the TMGI of multicast identifier corresponding to the multicast service and/or the G-RNTI for receiving the multicast service may be configured for the UE.

According to an embodiment, the G-RNTI and the TMGI may have a relationship. That is, the G-RNTI and the TMGI may be configured to be mapped, and the gNB may make a configuration for the UE regarding which G-RNTI is to be used to receive the designated multicast service.

According to an embodiment, physical downlink control channel (PDCCH) monitoring that uses a G-RNTI may be activated or deactivated, and activation or deactivation of the PDCCH monitoring may be indicated by a group paging message. The group paging message may include information indicating whether PDCCH monitoring that uses a G-RNTI corresponding to a multicast group (or multicast service) is to be activated or deactivated. The UE may perform PDCCH monitoring that uses a G-RNTI, based on the information included in the group paging message. For example, in case that the cell reselected by the UE provides all multicast services corresponding to the G-RNTI that activated PDCCH monitoring in the previous cell, the UE may continuously receive the multicast services in the inactive mode even after the cell reselection. For example, in case that the cell reselected by the UE does not provide at least one multicast service corresponding to the G-RNTI that activated PDCCH monitoring in the previous cell, the UE may initiate an RRC resume procedure for transitioning to the connected mode after cell reselection.

According to an embodiment, the UE needs to reset downlink HARQ information received by the UE in the previous cell in order to be provided with a multicast service in the reselected cell after cell reselection. Meanwhile, even in the case of the same multicast service, scheduling may be performed separately in different cells, thereby making it difficult to perform HARQ initial transmission and retransmission information at the same timepoint. Therefore, it cannot be guaranteed that retransmission of multicast data, the initial transmission was received by the UE in the previous cell, may be received after cell reselection. Therefore, it cannot be guaranteed that, even if retransmission is indicated to the UE by using the same G-RNTI, the same is retransmission of the data received in the previous cell.

Therefore, data received after cell reselection is made is considered as initial transmission, and is not to be combined with data stored in the HARQ soft buffer and then decoded. The operation in which data received after cell reselection is made is not combined with data stored in the HARQ soft buffer associated with initial transmission may be referred to as downlink HARQ reset in the disclosure. It will hereinafter be assumed that, in FIG. 2, the UE 200 receives a multicast service in the inactive mode from the first gNB 210. In the following description 280, the UE moves to the coverage of the second gNB 250 after the RRC-inactive multicast 230 so as to reselect 240 the second gNB 250, and then performs HARQ reset in order to receive a multicast service from the second gNB 250.

According to an embodiment, the downlink HARQ reset may be an operation of flushing the downlink HARQ soft buffer or a medium access control (MAC) reset operation involving the operation of flushing the soft buffer. Data received after cell reselection based on the operation of flushing the soft buffer and/or the MAC reset operation has no data (transport block) currently stored in the soft buffer and thus may be processed as initial transmission.

According to an embodiment, during the downlink HARQ reset, the first multicast data received in the current cell (e.g., reselected cell) may be considered or identified as initial transmission with regard to the HARQ process, regardless of whether or not there is data in the HARQ soft buffer, such that the same decoded without being combined with stored data.

According to an embodiment, in connection with the downlink HARQ reset, it may be considered that a new data indicator (NDI) is toggled with regard to the first downlink radio resource received by a G-RNTI in the current cell (e.g., reselected cell) with regard to the HARQ process.

According to an embodiment, in case that the cell is changed by cell reselection or the like during the downlink HARQ reset, the G-RNTI used in the changed cell may be considered as a G-RNTI different from the G-RNTI having the same value as the G-RNTI used in the previous cell, and the NDI may thus be processed as toggled. In case that the G-RNTI used to allocate the downlink resource received immediately before with regard to the same HARQ process is different from the G-RNTI used to allocate the current downlink resource, the UE may consider that the NDI is toggled with regard to the current downlink resource, and may process the same as initial transmission.

According to an embodiment, in case that the scheduling timepoint of downlink radio resources is substantially similar between adjacent cells, there may be no need to perform the downlink HARQ reset operation after cell reselection. The gNB may configure an indicator for the UE to indicate whether downlink HARQ reset is to be performed by the UE with regard to each adjacent cell after cell reselection. The indicator for indicating whether downlink HARQ reset is to be performed may be included on at least one of an MCCH message or an RRC release message and configured or provided to the UE.

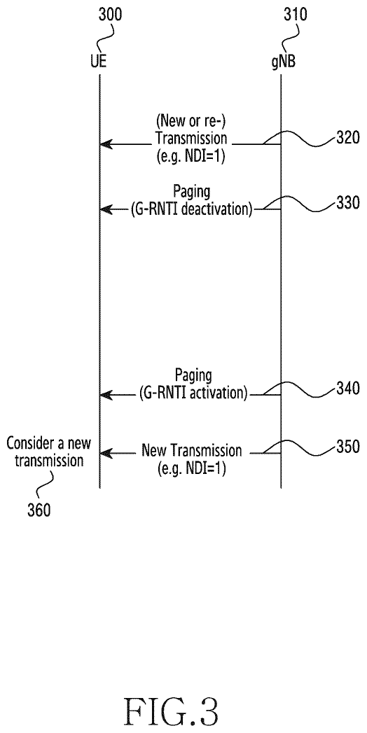

FIG. 3 illustrates an example of an operation for resetting a downlink HARQ during activation of G-RNTI monitoring according to an embodiment of the present disclosure.

Referring to FIG. 3, during multicast reception in an inactive mode, a UE 300 according to an embodiment may receive, from a gNB, configuration information for performing multicast reception in the active mode through at least one of an RRC reconfiguration message, an RRC setup message, an RRC reestablishment message, or an RRC release message in a connected mode.

According to an embodiment, the UE may receive, from the gNB, configuration information for performing multicast reception by using a MCCH received in the inactive state. In case that multicast data reception does not occur for a predetermined period of time due to deactivation of the multicast session that the UE is receiving in the inactive mode or for other reasons, the UE does not need to perform G-RNTI monitoring (PDCCH monitoring that uses a G-RNTI) in the inactive mode. The G-RNTI monitoring may be deactivated through a group paging or MCCH message. Deactivation of the G-RNTI monitoring may be indicated with regard to each G-RNTI or with regard to a TMGI mapped to the G-RNTI such that mapped G-RNTI monitoring is deactivated. For example, a G-RNTI may be mapped to a TMGI, and the TMGI may be mapped to G-RNTI monitoring. For example, a G-RNTI may be mapped to G-RNTI monitoring. In case that multicast data reception is resumed thereafter due to activation of the corresponding multicast session or other reasons, the UE needs to perform G-RNTI monitoring in the inactive mode. In order to perform G-RNTI monitoring, G-RNTI monitoring may be activated through a group paging or MCCH message. Activation of the G-RNTI monitoring may be indicated with regard to each G-RNTI or with regard to a TMGI mapped to the G-RNTI such that G-RNTI monitoring mapped to the TMGI is activated.

Referring to FIG. 3, the UE 300 may receive multicast data in the inactive mode from the gNB 310. It is assumed that the NDI value of multicast data received by the G-RNTI in step 320 is 1. Thereafter, in case that a group paging message is received in step 330 so as to indicate deactivation of PDCCH monitoring that uses the G-RNTI, the UE may not perform the PDCCH monitoring that uses the G-RNTI.

Although group paging that uses a paging message is assumed in FIG. 3, deactivation of G-RNTI monitoring may also be indicated through an MCCH message. Thereafter, in step 340, in case that PDCCH monitoring that uses a G-RNTI is activated, the UE may perform PDCCH monitoring that uses a G-RNTI. Thereafter, when the gNB receives data by using the G-RNTI, the gNB may fail to know the accurate NDI value received by the UE previously. The gNB may fail to identify the NDI value because of the inactive mode in which the UE's feedback does not exist, or because scheduling may have been performed with regard to other UEs by using the same G-RNTI during deactivation of G-RNTI monitoring. Therefore, as a downlink HARQ reset operation is performed in response to activation of G-RNTI monitoring, the UE may perform an operation in which data received after G-RNTI activation is processed as initial transmission in step 360.

According to an embodiment, the downlink HARQ reset may be an operation of flushing the downlink HARQ soft buffer or a MAC reset operation involving the operation of flushing the soft buffer. Data received after activation of G-RNTI monitoring based on the downlink HARQ reset has no data (e.g., transport block) currently stored in the soft buffer and thus may be processed or identified as initial transmission.

According to an embodiment, the downlink HARQ reset may be referred to as an operation in which the first multicast data received in the current cell after activation of G-RNTI monitoring with regard to the HARQ process, regardless of whether or not there is data in the HARQ soft buffer, is considered or identified as initial transmission such that the same is decoded without being combined with store data.

According to an embodiment, in connection with the downlink HARQ reset, it may be considered that a new data indicator (NDI) is toggled with regard to the first downlink radio resource received by a G-RNTI in the current cell after G-RNTI activation with regard to the HARQ process. According to an embodiment, in connection with the downlink HARQ reset, an operation may be performed such that the G-RNTI used acter activation of G-RNTI monitoring is considered as a G-RNTI different from the G-RNTI having the same value as the previously used G-RNTI, and the NDI is thus processed as toggled.

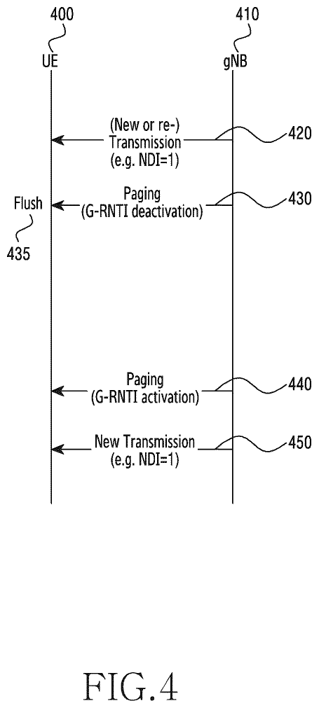

FIG. 4 illustrates an example of an operation for resetting a downlink HARQ during deactivation of G-RNTI monitoring according to an embodiment of the present disclosure.

Referring to FIG. 4, during multicast reception in an inactive mode, a UE 400 according to an embodiment may receive, from a gNB, configuration information for performing multicast reception in the inactive mode through at least one of an RRC reconfiguration message, an RRC setup message, an RRC reestablishment message, or an RRC release message in a connected mode.

According to an embodiment, the UE may receive, from the gNB, configuration information for performing multicast reception by using a MCCH received in the inactive state. In case that multicast data reception does not occur for a predetermined period of time due to deactivation of the multicast session that the UE is receiving in the inactive mode or for other reasons, the UE does not need to perform G-RNTI monitoring (PDCCH monitoring that uses a G-RNTI) in the inactive mode. The G-RNTI monitoring may be deactivated through a group paging or MCCH message. For example, a G-RNTI may be mapped to a TMGI, and the TMGI may be mapped to G-RNTI monitoring. For example, a G-RNTI may be mapped to G-RNTI monitoring. Deactivation of the G-RNTI monitoring may be indicated with regard to each G-RNTI or with regard to a TMGI mapped to the G-RNTI such that mapped G-RNTI monitoring is deactivated. In case that multicast data reception is resumed thereafter due to activation of the corresponding multicast session or other reasons, the UE needs to perform G-RNTI monitoring in the inactive mode. In order to perform G-RNTI monitoring, G-RNTI monitoring may be activated through a group paging or MCCH message. Activation of the G-RNTI monitoring may be indicated with regard to each G-RNTI or with regard to a TMGI mapped to the G-RNTI such that mapped G-RNTI monitoring is activated.

Referring to FIG. 4, it is assumed that the UE 400 receives multicast data in the inactive mode from the gNB 410. It is assumed that the NDI value of multicast data received by the G-RNTI in step 420 is 1. Thereafter, in case that a group paging message is received in step 430 so as to indicate deactivation of PDCCH monitoring that uses the G-RNTI, the UE 400 may not perform the PDCCH monitoring that uses the G-RNTI.

Although group paging that uses a paging message is assumed in FIG. 4, deactivation of G-RNTI monitoring may also be indicated through an MCCH message. Thereafter, when the gNB receives data by using the G-RNTI, the gNB may fail to know the accurate NDI value received by the UE previously. The gNB may fail to identify the NDI value previously received by the UE because of the inactive mode in which the UE's feedback does not exist, or because scheduling may have been performed by the gNB with regard to other UEs by using the same G-RNTI during deactivation of G-RNTI monitoring. Therefore, in case that G-RNTI monitoring is deactivated, the UE may perform an operation of flushing the downlink HARQ soft buffer stored by using the deactivated G-RNTI in step 435. According to an embodiment, flushing all downlink HARQ soft buffers of the UE may be performed.

According to an embodiment, in case that PDCCH monitoring that uses a G-RNTI is thereafter activated in step 440, the UE may perform PDCCH monitoring that uses a G-RNTI. Although group paging that uses a paging message is assumed in FIG. 4, activation of G-RNTI monitoring may also be indicated through an MCCH message. Accordingly, the first data of the HARQ process after activation of G-RNTI monitoring may be considered, identified, or determined as initial transmission regardless of the NDI value.

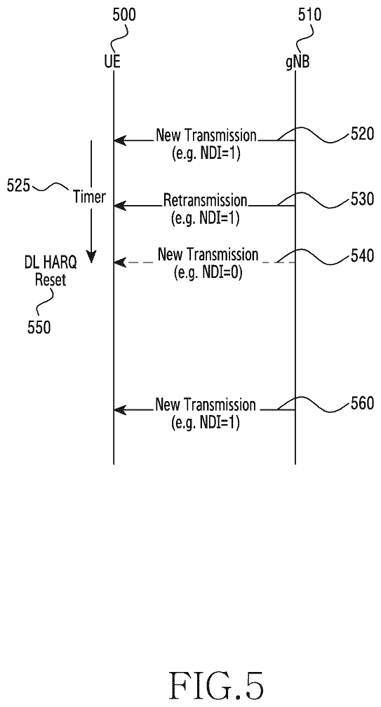

FIG. 5 illustrates an example of an operation for resetting a downlink HARQ during multicast reception in an inactive mode according to an embodiment of the present disclosure.

Referring to FIG. 5, the UE 500 in an inactive mode according to an embodiment may be unable to perform HARQ feedback. As a result, the gNB 510 may fail to know whether the UE 500 has successfully performed PDCCH decoding by using a G-RNTI. Failed PDCCH decoding by the UE may cause a problem in the NDI toggle operation which assumes that a PDCCH which has failed to be decoded has been delivered.

In FIG. 5, the gNB 510 may indicate initial transmission by using a G-RNTI and by configuring the NDI to be 1 in step 520. Thereafter, the gNB 510 may indicate downlink transmission through a radio resource by using the NDI value (the same NDI value of 1) in step 530. The UE may then determine that transmitted data is retransmitted data because the NDI value has not been toggled (changed). However, in step 540, in case that the gNB indicated new transmission (or initial transmission) by configuring the NDI value as 0, but the UE failed in PDCCH decoding, the UE 500 cannot know whether the NDI has been toggled or not. Thereafter, in step 560, in case that the gNB 510 performs transmission by toggling the NDI value to 1, the UE, which has failed in PDCCH decoding in step 540, may determine that transmitted data is retransmitted data, thereby failing to successfully receive downlink data.

However, the last previous transmission (e.g., step 530) made with the NDI value of 1 and the next transmission (e.g., step 560) are interposed by a transmission (e.g., step 540) indicated by the NDI value of 0, and this time interval may be relatively large. Therefore, the UE 500 may perform a downlink HARQ reset operation of the corresponding HARQ process after a predetermined time 525 with reference to the initial transmission timepoint in step 550. A method is described in FIG. 5 wherein a timer is driven in relation to the time for HARQ reset operation (for example, after a predetermined time with reference to the initial transmission timepoint) such that the HARQ soft buffer is flushed after timer expiration.

According to an embodiment, downlink HARQ reset may be an operation of flushing the downlink HARQ soft buffer or a MAC reset operation involving the operation of flushing the soft buffer. Data received after timer expiration based on the HARQ reset operation has no data (transport block) currently stored in the soft buffer and thus may be processed as initial transmission. According to an embodiment, in connection with the downlink HARQ reset, the UE may consider or identify the first multicast data received in the current cell after timer expiration with regard to the HARQ process, regardless of whether or not there is data in the HARQ soft buffer, as initial transmission such that the first multicast data can be decoded without combining the multicast data with stored data. According to an embodiment, in connection with the downlink HARQ reset, it may be considered that an NDI is toggled with regard to the first downlink radio resource received by a G-RNTI in the current cell after timer expiration with regard to the HARQ process. According to an embodiment, in connection with the downlink HARQ reset, an operation may be performed such that the G-RNTI used acter timer expiration is considered as a G-RNTI different from the G-RNTI having the same value as the previously used G-RNTI, and the NDI is thus processed as toggled.

As a result, the UE may perform an operation such that the multicast transmission (e.g., step 560) regarding the HARQ process, which has elapsed a predetermined time from the initial transmission timepoint, is considered as initial transmission, regardless of the PDCCH which has failed to be decoded.

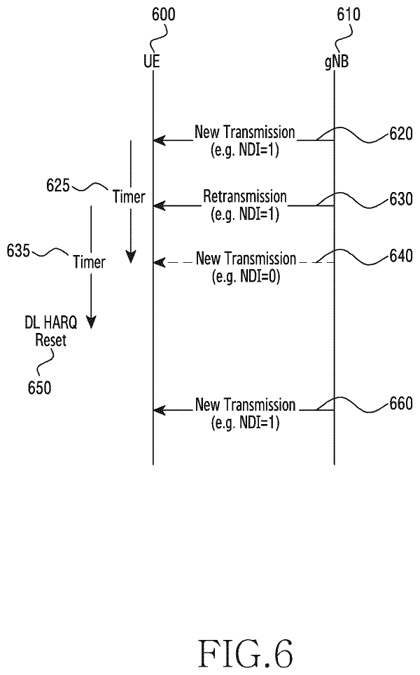

FIG. 6 illustrates an example of an operation for resetting a downlink HARQ during multicast reception in an inactive mode according to an embodiment of the present disclosure.

Referring to FIG. 6, the UE 600 in an inactive mode may be unable to perform HARQ feedback. As a result, the gNB 610 may fail to know whether the UE 600 has successfully performed PDCCH decoding by using a G-RNTI. Failed PDCCH decoding by the UE 600 may cause a problem in the NDI toggle operation which assumes that a PDCCH has been delivered.

In FIG. 6, the gNB 610 may indicate initial transmission by using a G-RNTI and by configuring the NDI to be 1 in step 620. Thereafter, the gNB 610 may indicate downlink transmission through a radio resource by using the NDI value (the same NDI value of 1) in step 630. The UE 600 may then determine that transmitted data is retransmitted data because the NDI value has not been toggled (changed). However, in step 640, in case that the gNB 610 indicated new transmission (or initial transmission) by configuring the NDI value as 0, but the UE 600 failed in PDCCH decoding, the UE 600 cannot know whether the NDI has been toggled or not. Thereafter, in step 660, in case that the gNB 610 performs transmission by toggling the NDI value to 1, the UE, which has failed in PDCCH decoding in step 640, may determine that data transmitted in step 660 is retransmitted data, thereby failing to successfully receive downlink data.

However, the last previous transmission (e.g., step 630) made with the NDI value of 1 and the next transmission (e.g., step 660) are interposed by a transmission (e.g., step 640) indicated by the NDI value of 0, and the time interval may thus be relatively large. Therefore, the UE 600 may perform a downlink HARQ reset operation of the HARQ process after a predetermined time with reference to the timepoint of initial transmission or retransmission in step 650. In case that there is an already operating timer at the timer starting timepoint, the UE may restart the timer. A method 625 or 635 is described in FIG. 6 wherein a timer is driven in relation to the time for HARQ reset operation such that the HARQ soft buffer is flushed after timer expiration.

According to an embodiment, downlink HARQ reset may be an operation of flushing the downlink HARQ soft buffer or a MAC reset operation involving the operation of flushing the soft buffer. Data received after timer expiration based on the HARQ reset has no data (transport block) currently stored in the soft buffer and thus may be processed as initial transmission.

According to an embodiment, in connection with the downlink HARQ reset, the UE may consider the first multicast data received in the current cell after timer expiration with regard to the HARQ process, regardless of whether or not there is data in the HARQ soft buffer, as initial transmission such that the first multicast data can be decoded without being combined with stored data.

According to an embodiment, in connection with the downlink HARQ reset, it may be considered that a new data indicator (NDI) is toggled with regard to the first downlink radio resource received by a G-RNTI in the current cell after timer expiration with regard to the HARQ process.

According to an embodiment, in connection with the downlink HARQ reset, an operation may be performed such that the G-RNTI used acter timer expiration is considered as a G-RNTI different from the G-RNTI having the same value as the previously used G-RNTI, and the NDI is thus processed as toggled.

As a result, the UE may perform an operation such that the multicast transmission (e.g., step 660) regarding the HARQ process, which has elapsed a predetermined time from the latest transmission timepoint, is considered as initial transmission with regard to the same NDI, regardless of the PDCCH which has failed to be decoded.

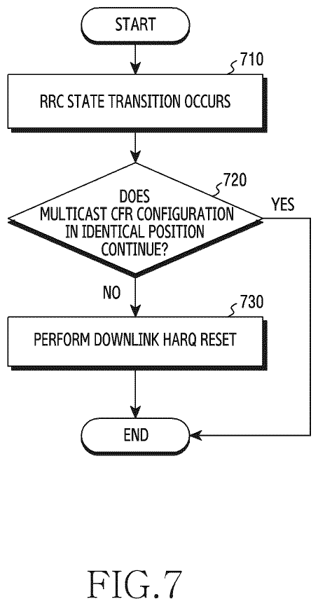

FIG. 7 illustrates an example of an operation for resetting a downlink HARQ during an RRC state transition according to an embodiment of the present disclosure.

Referring to FIG. 7, during multicast reception in an inactive mode, a UE 700 according to an embodiment may receive, from a gNB, configuration information for performing multicast reception in the inactive mode through at least one of an RRC reconfiguration message, an RRC setup message, an RRC reestablishment message, or an RRC release message in a connected mode.

According to an embodiment, the UE may receive, from the gNB, configuration information for performing multicast reception by using a MCCH received in the inactive state. Multicast reception may be performed in the inactive mode, based thereon. Thereafter, in case that the UE receives group paging, or cell reselection occurs and the UE thus camps on a cell in which the currently received multicast service is not provided in the inactive mode, the UE may perform an RRC resume operation to transition to an RRC connected mode. In case that the UE is incapable of continuous reception when an RRC state transition occurs, a downlink HARQ reset procedure may be necessary. However, in case that continuous reception is possible even if an RRC state transition occurs, the downlink HARQ reset may be unnecessary. Hereinafter, an operation will be described with reference to FIG. 7, wherein downlink HARQ reset is performed based on whether a common frequency resource (CFR) for multicast reception is changed during an RRC state transition.

Referring to FIG. 7, the UE may undergo a radio resource control (RRC) state transition in step 710. For example, the UE's state transition may correspond to initiation of an RRC resume procedure for transitioning from an inactive mode to a connected mode. That is, the UE's state may transition from an inactive mode state to a connected mode.

According to an embodiment, the UE may confirm or identify whether a multicast CFR in the same position is configured in step 720. For example, the UE may determine whether the multicast CFR in the same position is continued.

According to an embodiment, in case that a multicast CFR configured in an RRC resume message or an RRC release message, by which an RRC state transition occurs, is not configured in the same position as the previously configured multicast CFR, data may not be received continuously, and the UE may perform downlink HARQ in step 730.

According to an embodiment, the downlink HARQ reset may be an operation of flushing the downlink HARQ soft buffer or a MAC reset operation involving the operation of flushing the soft buffer. Data received after an RRC state transition, based on the downlink HARQ reset, has no data (e.g., transport block) currently stored in the soft buffer and thus may be processed or identified as initial transmission.

According to an embodiment, in connection with the downlink HARQ reset, the UE may consider or identify the first multicast data received after an RRC state transition with regard to the HARQ process, regardless of whether or not there is data in the HARQ soft buffer, as initial transmission such that the UE can decode the first multicast data without combining the first multicast data with stored data. In the disclosure, identification of initial transmission of data may be referred to as a case in which the data is substantially received first without retransmission. As another example, a case in which data corresponds to initial transmission may be referred to as a case in which the data is substantially not data retransmitted from the gNB. As another example, a case in which data corresponds to initial transmission may be referred to as a case in which the data is substantially the first data transmitted from the gNB without retransmission.

According to an embodiment, in connection with the downlink HARQ reset, the UE may consider that an NDI is toggled with regard to the first downlink radio resource received by a G-RNTI after an RRC state transition (in a transitioned RRC state) in the current cell (e.g., reselected cell) with regard to the HARQ process.

According to an embodiment, in connection with the downlink HARQ reset, the UE may perform an operation such that the G-RNTI used in the current RRC state after an RRC state transition is considered as a G-RNTI different from the G-RNTI having the same value as the G-RNTI used in the previous cell, and the NDI is thus processed as toggled.

According to an embodiment, in case that a multicast CFR in the same position is configured in step 720, the UE may be continuously receiving multicast data in the configured CFR. Therefore, in case that a multicast CFR in the same position is configured, the UE may continuously receive multicast data, based on the NDI value stored in the UE.

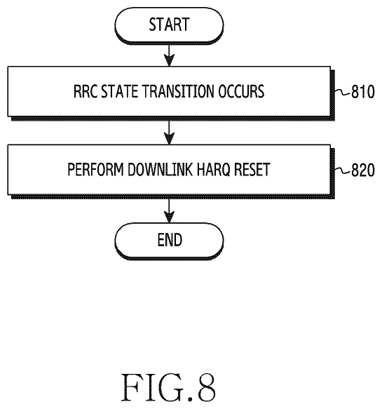

FIG. 8 illustrates an example of an operation for resetting a downlink HARQ during an RRC state transition according to an embodiment of the present disclosure.

Referring to FIG. 8, during multicast reception in an inactive mode, a UE according to an embodiment may receive, from a gNB, configuration information for performing multicast reception in the inactive mode, based on at least one of an RRC reconfiguration message, an RRC setup message, an RRC reestablishment message, or an RRC release message in a connected mode.

According to an embodiment, the UE may receive, from the gNB, configuration information for performing multicast reception by using a MCCH received in the inactive state. The UE may perform multicast reception in the inactive mode, based on the received configuration information. Thereafter, in case that the UE receives group paging, or cell reselection occurs and the UE thus camps on a cell in which the currently received multicast service is not provided in the inactive mode, the UE may perform an RRC resume operation to transition to an RRC connected mode. In case that the UE is incapable of continuous reception when an RRC state transition occurs, a downlink HARQ reset procedure may be necessary. An operation will be described with reference to FIG. 8, wherein downlink HARQ reset is performed during an RRC state transition.

Referring to FIG. 8, the UE may undergo an RRC state transition in step 810. For example, the UE's state transition may correspond to initiation of an RRC resume procedure for transitioning from an inactive mode to a connected mode. For example, the UE's state may transition from an inactive mode state to a connected mode. HARQ information (for example, NDI) that is being scheduled in the RRC connected mode may have a different value from the previous RRC state, and continuous reception of multicast data may thus be impossible. In case that continuous reception of multicast data is impossible, the UE may perform downlink HARQ reset in operation 830.

According to an embodiment, the downlink HARQ reset may be an operation of flushing the downlink HARQ soft buffer or a MAC reset operation involving the operation of flushing the soft buffer. Data received after an RRC state transition, based on the downlink HARQ reset, has no data (transport block) currently stored in the soft buffer and thus may be processed or identified as initial transmission.

According to an embodiment, in connection with the downlink HARQ reset, the UE may consider or identify the first multicast data received after an RRC state transition with regard to the HARQ process, regardless of whether or not there is data in the HARQ soft buffer, as initial transmission, and the UE may decode the first multicast data without combining the first multicast data with stored data.

According to an embodiment, in connection with the downlink HARQ reset, it may be considered or identified that an NDI is toggled with regard to the first downlink radio resource received by a G-RNTI after an RRC state transition (in a transitioned RRC state) in the current cell (for example, reselected cell) with regard to the HARQ process.

According to an embodiment, in connection with the downlink HARQ reset, the UE may perform an operation such that the G-RNTI used in the current RRC state after an RRC state transition is considered or identified as a G-RNTI different from the G-RNTI having the same value as the G-RNTI used in the previous cell, and the NDI is thus processed as toggled.

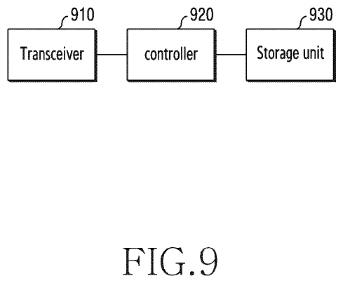

FIG. 9 illustrates an example of a gNB according to an embodiment of the present disclosure.

As used herein, the term/suffix such as “ . . . unit”/“-er” refer to a unit configured to process at least one function or operation, and the same may be implemented as hardware, software, or a combination of hardware and software.

Referring to FIG. 9, the gNB according to an embodiment may include a transceiver 910, a controller 920, and a storage 930. The gNB in FIG. 9 may correspond to the gNB 110 described with reference to FIG. 1. In addition, the gNB in FIG. 9 may correspond to the gNB described with reference to FIG. 1 to FIG. 8.

According to an embodiment, the controller 920 may be defined as a circuit or an application-specific integrated circuit or at least one processor. For example, the controller 920 may be replaced by the term “at least one processor.”

Operations performed by the gNB described with reference to FIG. 1 to FIG. 8 of the disclosure may be understood as being substantially performed by the controller 920 included in the gNB.

According to an embodiment, the transceiver 910 may transmit and/or receive signals with another network entity (for example, access and mobility management function (AMF)). For example, the transceiver 910 may include at least one transmitter and/or at least one receiver. For example, the transceiver 910 may include at least one circuit for processing radio frequency (RF) signals and/or intermediate frequency (IF) signals.

For example, during data transmission, the transceiver 910 encodes and modulates a transmitted bitstring so as to generate complex symbols. In addition, during data reception, the transceiver 910 restores a received bitstring by demodulating and decoding a baseband signal. In addition, the transceiver 910 up-converts a baseband signal to an RF band signal, transmits the same through an antenna, and down-converts an RF band signal received through the antenna to a baseband signal. For example, the transceiver 910 may include a transmission filter, a reception filter, an amplifier, a mixer, an oscillator, and/or a DAC, an ADC, and the like.

According to an embodiment, the transceiver 910 may transmit system information to an end and may transmit a synchronization signal and/or a reference signal.

According to an embodiment, the controller 920 may control overall operations of the gNB of the disclosure. For example, the controller 920 may control the flow of signals between respective blocks such that the operations of the gNB described with reference to FIG. 1 are FIG. 8 are performed.

According to an embodiment, the storage 930 may store at least one of information transmitted and/or received through the transceiver 910 and information or a control signal generated through the controller 920.

According to an embodiment, the storage 930 stores data such as default programs for the UE's operations, application programs, and configuration information. The storage 930 may be configured by a volatile memory, a nonvolatile memory, or a combination of a volatile memory and a nonvolatile memory. In addition, the storage 930 provides stored data at the request of the controller 920.

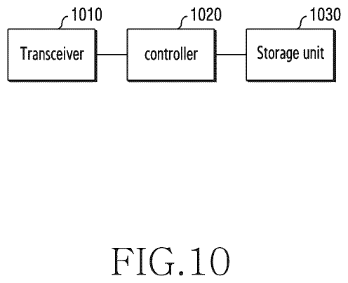

FIG. 10 illustrates an example of a UE according to an embodiment of the present disclosure.

As used herein, the term/suffix such as “ . . . unit”/“-er” refer to a unit configured to process at least one function or operation, and the same may be implemented as hardware, software, or a combination of hardware and software.

Referring to FIG. 10, the UE according to an embodiment may include a transceiver 1010, a controller 1020, and/or a storage 1030. In the disclosure, the storage 1030 may include at least one memory, and the at least one memory included in the storage 1030 may include instructions for controlling the controller 1020.

For example, during data transmission, the transceiver 1010 encodes and modulates a transmitted bitstring so as to generate complex symbols. In addition, during data reception, the transceiver 1010 restores a received bitstring by demodulating and decoding a baseband signal. In addition, the transceiver 1010 up-converts a baseband signal to an RF band signal, transmits the same through an antenna, and down-converts an RF band signal received through the antenna to a baseband signal. For example, the transceiver 1010 may include a transmission filter, a reception filter, an amplifier, a mixer, an oscillator, and/or a DAC, an ADC, and the like.

The UE in FIG. 10 may correspond to the UE described with reference to FIG. 1 to FIG. 9 of the disclosure. For example, the UE in FIG. 10 may correspond to UE 1 120 described with reference to FIG. 1. For example, the UE in FIG. 10 may correspond to UE 300 in FIG. 3. For example, the UE in FIG. 10 may correspond to UE 400 in FIG. 4.

Operations performed by the UE described with reference to FIG. 1 to FIG. 9 of the disclosure may be understood as being substantially performed by the controller 1020 included in the UE.

According to an embodiment, the controller 1020 may be defined as a circuit or an application-specific integrated circuit or at least one processor. For example, the controller 1020 may be replaced by the term “at least one processor.”

According to an embodiment, the transceiver 1010 may transmit and/or receive signals with another network entity (for example, AMF). For example, the transceiver 1010 of the UE transmit and/or receive signals with a network entity (for example, AMF) included in a core network through a gNB (for example, the gNB 110 in FIG. 1). For example, the transceiver 1010 may include at least one transmitter and/or at least one receiver. For example, the transceiver 1010 may include at least one circuit for processing radio frequency (RF) signals and/or intermediate frequency (IF) signals.

According to an embodiment, the transceiver 1010 may receive system information from the gNB and may receive a synchronization signal and/or a reference signal.

According to an embodiment, the controller 1020 may control overall operations of the UE described with reference to FIG. 1 to FIG. 9 of the disclosure. For example, the controller 1020 may control the flow of signals between respective blocks such that the operations of the UE described with reference to FIG. 1 are FIG. 9 are performed.

According to an embodiment, the storage 1030 may store at least one of information transmitted and/or received through the transceiver 1010 and information or a control signal generated through the controller 1020.

According to an embodiment, the storage 1030 stores data such as default programs for the UE's operations, application programs, and configuration information. The storage 1030 may be configured by a volatile memory, a nonvolatile memory, or a combination of a volatile memory and a nonvolatile memory. In addition, the storage 1030 provides stored data at the request of the controller 1020.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving a radio resource control (RRC) release message including multicast and broadcast services (MBS) configuration information associated with reception of an MBS multicast in an RRC inactive state;
performing cell reselection while the UE is in the RRC inactive state; and
resetting a medium access control (MAC) entity upon the cell reselection.

2. The method of claim 1, wherein the resetting of the MAC entity comprises:
flushing a soft buffer for all hybrid automatic repeat request (HARQ) processes.

3. The method of claim 1, further comprising:
camping on a cell identified based on the cell reselection; and
receiving, from a base station on the cell, the MBS multicast on the cell.

4. The method of claim 3, further comprising:
identifying a transmission for the MBS multicast as a first transmission.

5. The method of claim 1, further comprising:
receiving, from a base station, a multicast multicast control channel (MCCH) message, the multicast MCCH message including information indicating to stop monitoring a group-radio network temporary identifier (G-RNTI) for the MBS multicast.

6. A user equipment (UE) in a wireless communication system, the UE comprising:
a transceiver; and
a controller coupled with the transceiver and configured to:
receive a radio resource control (RRC) release message including multicast and broadcast services (MBS) configuration information associated with reception of an MBS multicast in an RRC inactive state,
perform cell reselection while the UE is in the RRC inactive state, and
reset a medium access control (MAC) entity upon the cell reselection.

7. The UE of claim 6, wherein the controller is further configured to:
flush a soft buffer for all hybrid automatic repeat request (HARQ) processes.

8. The UE of claim 6, wherein the controller is further configured to:
camp on a cell identified based on the cell reselection, and
receive, from a base station on the cell, the MBS multicast on the cell.

9. The UE of claim 8, wherein the controller is further configured to:
identify a transmission for the MBS multicast as a first transmission.

10. The UE of claim 6, wherein the controller is further configured to:
receive, from a base station, a multicast multicast control channel (MCCH) message, the multicast MCCH message including information indicating to stop monitoring a group-radio network temporary identifier (G-RNTI) for the MBS multicast.

11. A method performed by a user equipment (UE) in a wireless communication system, the method comprising:
receiving a radio resource control (RRC) release message including multicast and broadcast services (MBS) configuration information associated with reception of an MBS multicast in an RRC inactive state;
receiving, from a base station, a RRC resume message while the UE is in the RRC inactive state; and
resetting a medium access control (MAC) entity based on the RRC resume message.

12. The method of claim 11, wherein the resetting of the MAC entity comprises:
flushing a soft buffer for all hybrid automatic repeat request (HARQ) processes.

13. The method of claim 11, further comprising:
receiving, from the base station, an MBS multicast while the UE is in an RRC connected state.

14. The method of claim 13, further comprising:
identifying a transmission for the MBS multicast received while the UE is in the RRC connected state as a first transmission.

15. The method of claim 11, further comprising:
receiving, from the base station, a multicast multicast control channel (MCCH) message, the multicast MCCH including information indicating to stop monitoring a group-radio network temporary identifier (G-RNTI) for the MBS multicast.

16. A user equipment (UE) in a wireless communication system, the UE comprising:
a transceiver; and
a controller coupled with the transceiver and configured to:
receive a radio resource control (RRC) release message including multicast and broadcast services (MBS) configuration information associated with reception of an MBS multicast in an RRC inactive state,
receive, from a base station, a RRC resume message while the UE is in the RRC inactive state, and
reset a medium access control (MAC) entity based on the RRC resume message.

17. The UE of claim 16, wherein the controller is further configured to:
flush a soft buffer for all hybrid automatic repeat request (HARQ) processes.

18. The UE of claim 16, wherein the controller is further configured to:
receive, from the base station, an MBS multicast while the UE is in an RRC connected state.

19. The UE of claim 18, wherein the controller is further configured to:
identify a transmission for the MBS multicast received while the UE is in the RRC connected state as a first transmission.

20. The UE of claim 16, wherein the controller is further configured to:
receive, from the base station, a multicast multicast control channel (MCCH) message, the multicast MCCH including information indicating to stop monitoring a group-radio network temporary identifier (G-RNTI) for the MBS multicast.
